(19) United States
(12) Patent Application Publication
(10) Pub. No.: US 2013/0058321 A1
(43) Pub. Date: Mar. 7, 2013

(54) COMMUNICATION DEVICE, DISTRIBUTION SYSTEM, DISTRIBUTION DATA PROCESSING METHOD, AND DISTRIBUTION DATA PROCESSING PROGRAM

(71) Applicants: Hirofumi Hamazaki, Osaka-shi (JP); Akira Tojima, Osaka-shi (JP); Junichi Shirakawa, Osaka-shi (JP)

(72) Inventors: Hirofumi Hamazaki, Osaka-shi (JP); Akira Tojima, Osaka-shi (JP); Junichi Shirakawa, Osaka-shi (JP)

(73) Assignee: SHARP KABUSHIKI KAISHA, Osaka-shi, Osaka (JP)

(21) Appl. No.: 13/696,545

(22) PCT Filed: May 31, 2011
(86) PCT No.: PCT/JP2011/062488

§ 371 Date: Nov. 6, 2012

(30) Foreign Application Priority Data
Jun. 3, 2010 (JP) 2010-127772

(51) Int. Cl. H04W 84/12

(52) U.S. Cl. 370/338

(57) ABSTRACT

An electronic coupon is distributed from a management server to a mobile device via the Internet, communication setting data defining a communication condition and effectiveness of this electronic coupon is transmitted to a shop apparatus. When the mobile device enters a range in which near field communication with the shop apparatus is possible, communication between the mobile device and the shop apparatus is established based on the communication condition. Further, when it is determined that the electronic coupon held by the mobile device is effective for this shop apparatus, the mobile device is notified of a presence of a shop associated with the held electronic coupon in the vicinity.

### TECHNICAL FIELD

This invention relates to communication devices, distribution systems, distribution data processing methods, and distribution data processing programs, and in particular to a communication device for processing data related to a facility, a distribution system, a distribution data processing method, and a distribution data processing program.

### BACKGROUND ART

One method of promoting use of a facility is to distribute advertising information related to this facility to communication devices such as mobile telephones.

Examples of means that a user uses a mobile device to have communication at a facility away from home include Hotspot®. Hotspot is a service to provide the Internet connection or services unique to the facility by placing an access point for a wireless LAN (Local Area Network) within a public facility or a shop, and allowing a mobile device of a user to access to the wireless LAN connection.

A technique of distributing advertising information utilizing this system has been proposed as one example of techniques of distributing advertising information of the facility to the mobile device.

However, in a conventional application of Hotspot, there is a problem that a user operation is cumbersome as the user is required to operate the mobile device to input information for authentication when connecting.

As means for solving this problem, Japanese Patent Laying-Open No. 2005-73147 (hereinafter, Patent Literature 1) discloses an advertisement production and transmission system corresponding to individual users capable of transmitting an electronic advertisement, to a terminal of a user who is present near a distributor shop, of a product of the distributor shop corresponding to the user's willingness to buy via an outdoor wireless LAN.

According to the method disclosed in Patent Literature 1, user-related information such as preference information and mobile device information are previously registered to the system, an approach of a user carrying a mobile device to a distributor shop is detected, the system produces an electronic advertisement that would cause the user to have willingness to buy, and the electronic advertisement is transmitted to the mobile device via the wireless LAN at the distributor shop. With this, the user is guided to the distributor shop.

### CITATION LIST

### Patent Literature

### PTL 1: Japanese Patent Laying-Open No. 2005-73147

### SUMMARY OF INVENTION

### Technical Problem

However, according to the method disclosed in Patent Literature 1, the advertising information is distributed only when the user approaches the distributor shop, and therefore it is not possible to distribute information that is more effective when distributed at timing when the user is away from the distributor shop, such as advertising information that is desired to be previously distributed like coupons, to a mobile terminal of the user.

The present invention has been made in view of the above problem, and an object of the present invention is to provide a communication device capable of processing data related to a facility at appropriate timing, a distribution system, a distribution data processing method, and a distribution data processing program.

### Solution to Problem

In order to achieve the above object, one aspect of the present invention provides a communication device provided with: a communication unit for performing wireless communication with another device or an access point for a network within a predetermined communication range; a storage unit; a search unit for searching distribution data in the storage unit, the distribution data containing a communication condition of a predetermined item; a communication control unit for controlling the communication of the communication unit with the another device or the access point based on the communication condition contained in the distribution data; and a notification unit for notifying that distribution data that allows communication connection is recorded through an output unit after the communication of the communication unit with the another device or the access point is established.

Preferably, the distribution data is configured as image data, and the communication condition is included in header information of the image data.

Preferably, the communication condition contained in the distribution data includes at least one of a network ID for identifying a network through which the wireless communication is performed, a security method, and a password necessary for the wireless communication, and the communication control unit causes the communication unit to perform the communication with the another device or the access point using at least one of the network ID, the security method, and the password included in the communication condition.

Preferably, the communication condition contained in the distribution data includes a network ID for identifying a network through which the wireless communication is performed, and the communication control unit causes the communication unit to repeatedly attempt connection to the access point of the network using the network ID.

Preferably, the communication condition contained in the distribution data includes a network ID for identifying a network through which the wireless communication is performed, and the communication control unit searches one or more networks through which wireless communication is performed, identifies one of the searched networks that matches the network ID as the network through which the wireless communication is performed, and causes the communication unit to connect to the access point of the identified network.

Preferably, the communication condition contained in the distribution data includes a password necessary for the wireless communication, and the communication control unit performs the password authentication in response to a connection request from the another device, and starts connection between the communication unit and the another device when the authentication is successful.

Preferably, the distribution data is one of data attached to an e-mail distributed from a server and data that the communication unit receives from the another device.

Preferably, the notification unit makes the notification when the communication unit establishes the communication with another device or the access point, and when a predetermined condition is satisfied with the another device.

More preferably, the predetermined condition is reception of a response from the another device, the response indicating that the communication condition contained in the distribution data is satisfied.

More preferably, after the communication unit establishes the communication with the another device or the access point, the communication device transmits at least one of information for identifying a facility in which the another device or the access point is placed, information for identifying a position of the facility, and an effective period of the distribution data is transmitted to the another device, and receives a response indicating whether or not the communication condition contained in the distribution data is satisfied from the another device.

Preferably, the notification unit performs the notification using at least one of vibration, sound, light, and an image.

Preferably, the communication unit performs communication based on a wireless communication method whose communicable range is a near field range.

Another aspect of the present invention provides a distribution system provided with: a plurality of communication devices, wherein a first communication device distributes distribution data containing at least a communication condition of a predetermined item to another communication devices, a second communication device includes: a communication unit for performing wireless communication with a third communication device or an access point for a network to which the third communication device is connected within a predetermined communication range; a communication control unit for controlling the communication of the communication unit with the third communication device or the access point based on the communication condition contained in the distribution data distributed from the first communication device; and a notification unit for notifying that distribution data that allows communication connection is recorded through an output unit after the communication of the communication unit with the third communication device or the access point is established, the third communication device or the access point includes: a communication unit for performing wireless communication with another communication device within a predetermined communication range; and an informing unit for determining whether or not communication of the communication unit with the second communication device is allowed based on the communication condition contained in the distribution data distributed from the first communication device and a communication request from the second communication device, and for informing the second communication device of the determination, and when the informing unit of the third communication device or the access point has informed that the communication between the second communication device and the third communication device or the access point is allowed, the communication between the second communication device and the third communication device is established.

Further another aspect of the present invention provides a distribution data processing method for a communication device, the communication device including a communication unit for performing wireless communication with another device or an access point for a network within a predetermined communication range, the method being provided with: a step of receiving distribution data from the another device and storing the distribution data in a recording device; a step of searching distribution data in the recording device, the distribution data containing a communication condition of a predetermined item; a step of controlling the communication of the communication unit with the another device or the access point based on the communication condition contained in the distribution data; and a step of notifying that distribution data that allows communication connection is recorded through an output unit after the communication of the communication unit is established.

Yet another aspect of the present invention provides a distribution data processing program for causing a computer to execute distribution data processing, the computer including a communication unit for performing wireless communication with another device or an access point for a network within a predetermined communication range, the distribution data processing being provided with: a step of receiving distribution data from the another device and storing the distribution data in a recording device; a step of searching distribution data in the recording device, the distribution data containing a communication condition of a predetermined item; a step of controlling the communication of the communication unit with the another device or the access point based on the communication condition contained in the distribution data; and a step of notifying that distribution data that allows communication connection is recorded through an output unit after the communication of the communication unit with the another device or the access point is established.

### Advantageous Effects of Invention

According to this invention, when a user carrying a mobile device approaches a facility, it is possible to inform the user that a facility related to the held distribution data is in the vicinity regardless of the user's awareness of this facility, and to guide the user to this facility. Further, as the user is able to previously receive the distribution data (electronic coupon) of the facility, it is possible to provided information to guide the user to the facility even when the user is away from this facility. With this, the user is able to visit the facility after checking the distribution data. Further, for the service provider, a greater effect of attracting customers is expected.

### BRIEF DESCRIPTION OF DRAWINGS

FIG. 1 is a block diagram illustrating a specific example of a configuration of a distribution system according to an embodiment of the invention.

FIG. 2 is a block diagram illustrating a specific example of a configuration of a shop apparatus included in the distribution system according to the embodiment of the invention.

FIG. 3 is a block diagram illustrating a specific example of a configuration of a mobile device included in the distribution system according to the embodiment of the invention.

FIG. 4 is a view illustrating a specific example of an external appearance of the mobile device included in the distribution system according to the embodiment, where the mobile device is a mobile telephone.

FIG. 5 is a block diagram illustrating a specific example of a configuration of a management server included in the distribution system according to the embodiment of the invention.

FIG. 6 is a view illustrating a specific example of a data configuration of an electronic coupon.

FIG. 7A is a view illustrating a specific example of a structure of communication setting data when IEEE 802.11 wireless communication is performed between the mobile device and the shop apparatus.

FIG. 7B is a view illustrating a specific example of a structure of communication setting data when wireless communication using Bluetooth® is performed between the mobile device and the shop apparatus.

FIG. 8 is a flowchart showing a process flow in the management server.

FIG. 9 is a flowchart showing a process flow in the shop apparatus.

FIG. 10 is a flowchart showing a process flow in the mobile device.

FIG. 11A is a view illustrating a specific example of a display screen of the mobile device.

FIG. 11B is a view illustrating a specific example of a display screen of the mobile device.

FIG. 11C is a view illustrating a specific example of a display screen of the mobile device.

FIG. 12A is a view illustrating a specific example of a display screen of the mobile device.

FIG. 12B is a view illustrating a specific example of a display screen of the mobile device.

FIG. 12C is a view illustrating a specific example of a display screen of the mobile device.

FIG. 13 is a flowchart showing a connecting process in the shop apparatus when communication between the shop apparatus and the mobile device is IEEE 802.11 wireless communication.

FIG. 14 is a flowchart showing a connecting process in the mobile device when communication between the shop apparatus and the mobile device is IEEE 802.11 wireless communication and when an SSID is not open.

FIG. 15 is a flowchart showing a connecting process in the mobile device when communication between the shop apparatus and the mobile device is IEEE 802.11 wireless communication and when the SSID is open.

FIG. 16 is a flowchart showing a connecting process in the shop apparatus when communication between the shop apparatus and the mobile device uses Bluetooth®.

FIG. 17 is a flowchart showing a connecting process in the mobile device when communication between the shop apparatus and the mobile device uses Bluetooth®.

FIG. 18A is a view illustrating a specific example of transition of a display screen of a transmitting-end mobile device when an electronic coupon is transferred between mobile devices through communication using Bluetooth®.

FIG. 18B is a view illustrating a specific example of transition of the display screen of the transmitting-end mobile device when the electronic coupon is transferred between the mobile devices through communication using Bluetooth®.

FIG. 18C is a view illustrating a specific example of transition of the display screen of the transmitting-end mobile device when the electronic coupon is transferred between the mobile devices through communication using Bluetooth

FIG. 18D is a view illustrating a specific example of transition of the display screen of the transmitting-end mobile device when the electronic coupon is transferred between the mobile devices through communication using Bluetooth®.

FIG. 19A is a view illustrating a specific example of transition of a display screen of a receiving-end mobile device when an electronic coupon is transferred between mobile devices through communication using Bluetooth®.

FIG. 19B is a view illustrating a specific example of transition of the display screen of the receiving-end mobile device when the electronic coupon is transferred between the mobile devices through communication using Bluetooth®.

FIG. 19C is a view illustrating a specific example of transition of the display screen of the receiving-end mobile device when the electronic coupon is transferred between the mobile devices through communication using Bluetooth®.

FIG. 19D is a view illustrating a specific example of transition of the display screen of the receiving-end mobile device when the electronic coupon is transferred between the mobile devices through communication using Bluetooth

FIG. 20A is a view illustrating a specific example of transition of the display screen of the mobile device when an electronic coupon stored in the mobile device is deleted.

FIG. 20B is a view illustrating a specific example of transition of the display screen of the mobile device when the electronic coupon stored in the mobile device is deleted.

FIG. 20C is a view illustrating a specific example of transition of the display screen of the mobile device when the electronic coupon stored in the mobile device is deleted.

FIG. 21A is a view illustrating a specific example of transition of the display screen of the mobile device when the electronic coupon stored in the mobile device is deleted.

FIG. 21B is a view illustrating a specific example of transition of the display screen of the mobile device when the electronic coupon stored in the mobile device is deleted.

FIG. 21C is a view illustrating a specific example of transition of the display screen of the mobile device when the electronic coupon stored in the mobile device is deleted.

### DESCRIPTION OF EMBODIMENTS

Hereinafter, an embodiment of the present invention is described with reference to the drawings. In the following description, the same parts and components are represented by the same reference numerals. Names and functions of such parts and components are the same.

FIG. 1 is a block diagram illustrating a specific example of a configuration of a distribution system according to this embodiment.

Referring to FIG. 1, the distribution system includes a mobile device 1 as a communication apparatus carried by a user, a shop apparatus 3 as a communication apparatus placed in a shop, and a management server 5 as a server for managing information to be distributed.

Mobile device 1 can include a plurality of devices such as mobile devices 1A, 1B, . . . as illustrated in FIG. 1. Communication via the Internet, near field wireless communication, and wire communication are performed between these devices.

Both between shop apparatus 3 and management server 5 and between mobile device 1 and management server 5, communication via the Internet is performed.

Between shop apparatus 3 and mobile device 1, near field wireless communication or close-range wireless communication is performed. Specifically, between shop apparatus 3 and mobile device 1, wireless communication with a communication range of tens of meters or so is performed, and specific examples of such communication include IEEE 802.11 wireless communication, Bluetooth®, and Zigbee®.

An information providing system according to this embodiment assumes that communication setting data is transmitted from management server 5 to shop apparatus 3, the communication setting data being data at least defining a communication condition of an electronic coupon. With this, shop apparatus 3 is able to communicate with mobile device 1 that has obtained an electronic coupon as distribution data. Further, an electronic coupon is distributed from management server 5 to mobile device 1 by such as e-mail. In a case in which a network satisfying a condition defined by communication data of communication setting data added to the electronic coupon is present within a range in which communication is possible, mobile device 1 attempts wireless communication connection with shop apparatus 3 using the communication setting data added to the electronic coupon. Then, when communication connection is established, mobile device 1 notifies of a presence of the shop associated with the electronic coupon in the vicinity.

Functional configurations of the devices that realize the above sequential flow are described below with reference to the drawings.

As used herein, the “shop” refers to a service point that is fixed at a predetermined position and attempts to distribute information to mobile device 1, and shop apparatus 3 is configured, for example, by a personal computer (PC) and a wireless access point placed in this shop.

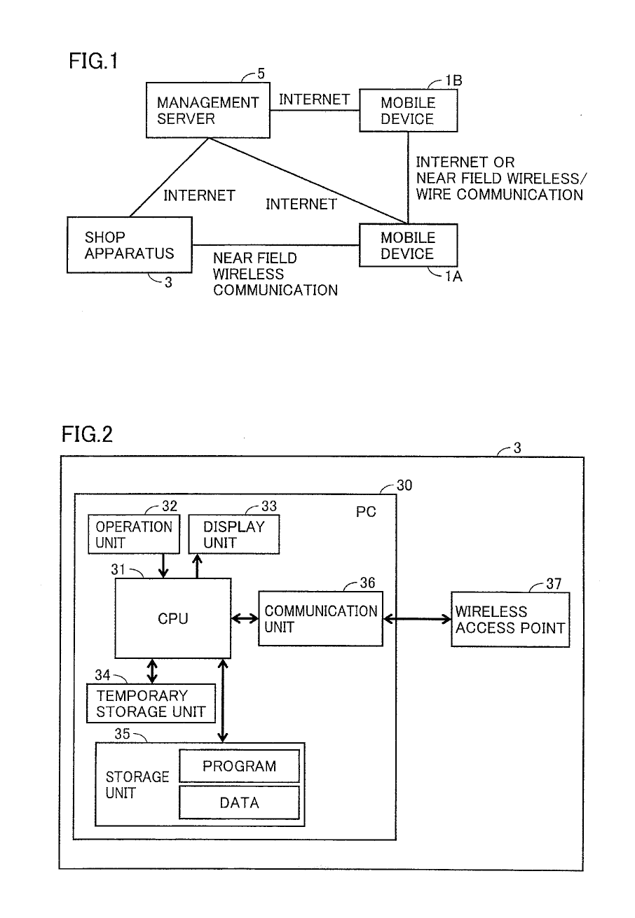

FIG. 2 is a block diagram illustrating a specific example of a configuration of shop apparatus 3. Here, as described above, shop apparatus 3 is assumed to be configured by PC 30 and wireless access point 37. Shop apparatus 3 can be configured as a single apparatus including the PC and the wireless access point all-in-one.

Referring to FIG. 2, shop apparatus 3 includes PC 30 and wireless access point 37, and PC 30 includes a CPU (Central Processing Unit) 31, an operation unit 32 for accepting a user operation, a display unit 33 for displaying information, a temporary storage unit 34 used as such as a working area of CPU 31, a storage unit 35 for recording a program and data, and a communication unit 36.

Wireless access point 37 is a wireless equipment for connecting to a communication network such as Ethernet® by performing IEEE 802.11 wireless communication, for example.

To be more specific, storage unit 35 is configured by a non-volatile and high-capacity device that records a program and data, examples of the device including an HDD (Hard Disk Drive), an SSD (Solid State Drive), and a flash memory card. CPU 31 controls this device and performs arithmetic processing by executing the program recorded in storage unit 35. Temporary storage unit 34 is typically configured by a volatile and high-speed device such as a DRAM (Dynamic Random Access Memory), and functions as a working memory that temporarily executes recording in execution of the program by CPU 31.

Display unit 33 is configured by a liquid crystal panel and such and displays image information. Operation unit 32 is realized by such as a keyboard or a mouse, for example.

Communication unit 36 is realized, for example, by Ethernet®, and communicates with management server 5 via the Internet or with wireless access point 37.

The “mobile device” can be any communication apparatus as long as the user can take along, and configured as a mobile telephone, a game console, or a PDA (Personal Digital Assistants), for example.

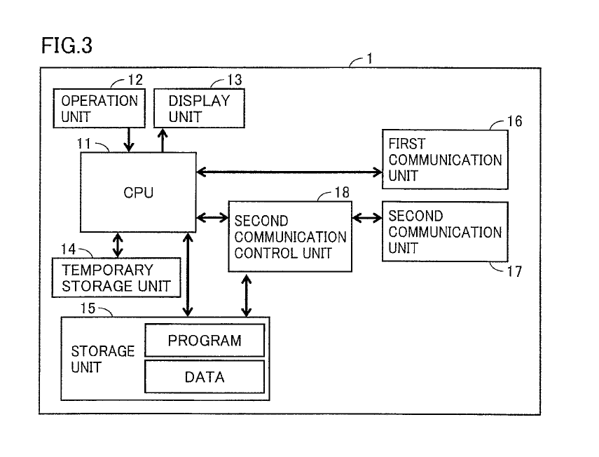

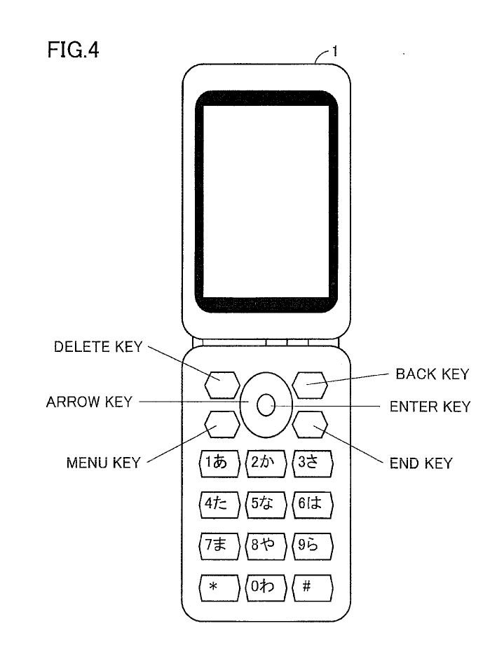

FIG. 3 is a block diagram illustrating a specific example of a configuration of mobile device 1. Here, as described above, mobile device 1 is assumed to be configured by a mobile telephone as illustrated in FIG. 4.

Referring to FIG. 3, mobile device 1 includes a CPU 11, an operation unit 12 for accepting a user operation, a display unit 13 for displaying information, a temporary storage unit 14 used as such as a working area of CPU 11, a storage unit 15 for recording a program and data, a first communication unit 16 for realizing mobile telephone communication, a second communication unit 17 for realizing wireless communication, and a second communication control unit 18 for controlling second communication unit 17.

To be more specific, storage unit 15 is configured by a non-volatile and high-capacity device that records a program and data, examples of the device including an HDD, an SSD, and a flash memory card. CPU 11 controls this device and performs arithmetic processing by executing the program recorded in storage unit 15. Temporary storage unit 14 is typically configured by a volatile and high-speed device such as a DRAM, and functions as a working memory that temporarily executes recording in execution of the program by CPU 11.

Display unit 13 is configured by a liquid crystal panel and such and displays image information. Operation unit 12 is realized by such as buttons provided around a screen of display unit 13, and the buttons in an example illustrated in FIG. 4 include a delete key, an arrow key, a back key, an end key, an enter key, number and letter keys and such.

First communication unit 16 allows the Internet access by connecting to a mobile telephone network of the 3rd generation of mobile telecommunications technology (3G) and such.

Second communication unit 17 realizes, for example, IEEE 802.11 wireless communication, but can perform communication using such as Bluetooth® or Zigbee® like first communication unit 16.

Second communication control unit 18 can be a function realized by CPU 11 executing the program, and allows communication with communication unit 36 within shop apparatus 3 or with wireless access point 37 within shop apparatus 3 to be established using second communication unit 17.

Management server 5 is a server for distributing an “electronic coupon”. Management server 5 is configured by such as a PC, for example. As used herein, the “electronic coupon” refers to distribution data as a kind of advertising information associated with a predetermined shop. Details will be described later.

FIG. 5 is a block diagram illustrating a specific example of a configuration of management server 5. Here, as described above, management server 5 is assumed to be configured by a PC.

Referring to FIG. 5, management server 5 includes a CPU 51, an operation unit 52 for accepting a user operation, a display unit 53 for displaying information, a temporary storage unit 54 used as such as a working area of CPU 51, a storage unit 55 for recording a program and data, and a communication unit 56 for performing communication using the Internet.

To be more specific, storage unit 55 is configured by a non-volatile and high-capacity device that records a program and data, examples of the device including an HDD, an SSD, and a flash memory card. CPU 51 controls this device and performs arithmetic processing by executing the program recorded in storage unit 55. Temporary storage unit 54 is typically configured by a volatile and high-speed device such as a DRAM, and functions as a working memory that temporarily executes recording in execution of the program by CPU 51.

Display unit 53 is configured by a liquid crystal panel and such and displays image information. Operation unit 52 is realized by such as a keyboard or a mouse, for example.

Communication unit 56 realizes connection to the Internet by Ethernet®, for example.

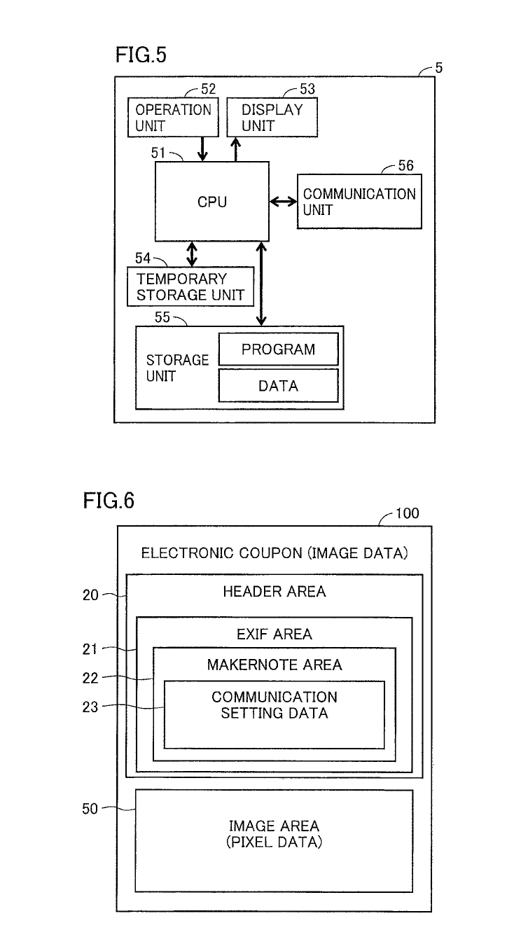

FIG. 6 is a view illustrating a specific example of a data configuration of the electronic coupon. Here, the data configuration of the electronic coupon will be described with reference to FIG. 6. FIG. 6 shows an example in which the electronic coupon is configured by an image file in a format such as JPEG (Joint Photographic Experts Group).

Referring to FIG. 6, an electronic coupon 100 as image data roughly includes a header area 20 and an image area 50 as an area for holding pixel data of an image. Header area 20 is an area containing attribute data of the image, and includes an EXIF area 21 that is defined by EXIF (Exchangeable Image File Format) standard. EXIF area 21 includes a makernote area 22 having a uniquely expandable area, which further contains communication setting data 23.

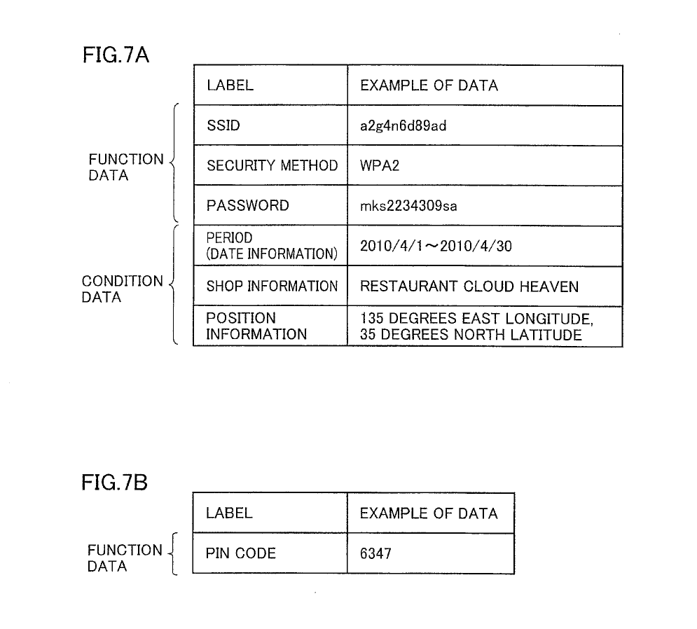

As used herein, the “communication setting data” refers to data for setting a condition for communication between shop apparatus 3 associated with this electronic coupon and mobile device 1. FIG. 7 shows views illustrating a data structure of the communication setting data. FIG. 7A is a view illustrating a specific example of the structure of communication setting data 23 when IEEE 802.11 wireless communication is performed between mobile device 1 and shop apparatus 3.

Referring to FIG. 7A, communication setting data 23 roughly includes communication data as information necessary to establish communication and condition data as a condition regarding whether or not a service provided by an electronic coupon is effective.

To be more specific, the communication data includes at least one of a network ID as an ID for identifying a network through which a predetermined wireless communication is performed, a security method for this wireless communication, and a password necessary for this wireless communication. In the example shown in FIG. 7A, an SSID (Service Set Identifier) as an identifier of an access point in the IEEE 802.11 wireless communication as the network ID, a security method for communication between mobile device 1 and shop apparatus 3 as the security method, and the password necessary for wireless communication between the devices are defined.

The condition data includes at least one of an effective period of this electronic coupon, information identifying a shop in which shop apparatus 3 is placed, and information identifying a position of this shop. In the example shown in FIG. 7A, a period as the effective period of this electronic coupon, a shop name associated as information identifying the shop, and latitude and longitude as information identifying the position of this shop are defined.

It should be noted that when mobile device 1 and shop apparatus 3 communicate using Bluetooth® as another communication method, the communication data in the data structure of communication setting data 23 includes only the password necessary for wireless communication between the devices as illustrated in FIG. 7B, and a PIN code that is a number of 4 digits (or digits greater than or equal to 4) required to be inputted in pairing is defined as the password.

By producing an electronic coupon as image data in this manner, it is possible to perform a process, without particularly changing software, using functions normally provided for mobile phones and PCs, such as a function of storing and deleting, a function of transmitting and receiving between devices, and a function of transmitting and receiving an image attached to an e-mail.

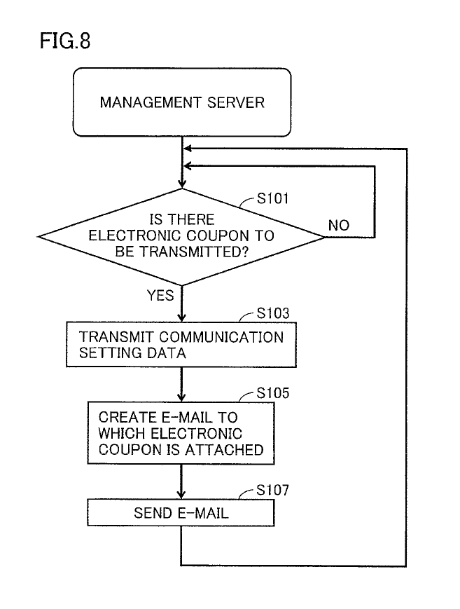

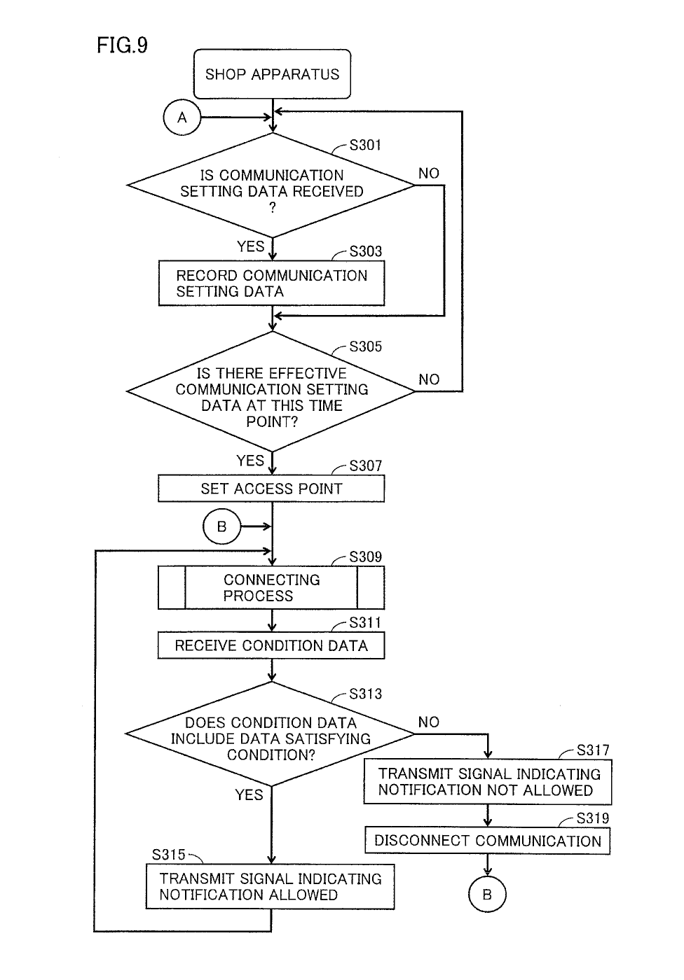

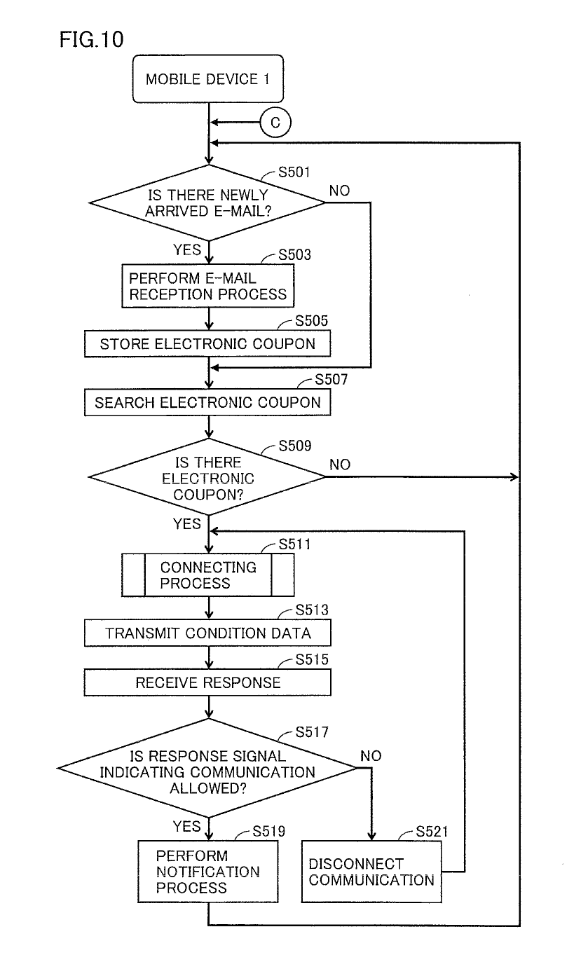

FIGS. 8, 9, and 10 respectively are flowcharts each showing a process flow in the information providing system according to this embodiment. FIG. 8 is a flowchart showing a process flow in management server 5, FIG. 9 is a flowchart showing a process flow in shop apparatus 3, and FIG. 10 is a flowchart showing a process flow in mobile device 1. The process shown in each flowchart is realized by the CPU included in the corresponding apparatus reading and executing the program recorded in the storage unit, and controlling illustrated components.

First, referring to FIG. 8, in management server 5, CPU 51 checks whether or not an electronic coupon to be transmitted is present at predetermined timing such as after power activation (step S101). An electronic coupon is assumed to be previously registered to management server 5 by a user and such of shop apparatus 3, for example. As one example of the check of the electronic coupon to be transmitted, CPU 51 checks a presence of information of an electronic coupon that has been newly added to a specific storage area of storage unit 55.

When it is determined that the electronic coupon to be transmitted is present (YES in step s101), the communication setting data included in the electronic coupon is transmitted to each shop apparatus 3 (step S103). Here, it is assumed that the electronic coupon is transmitted to all of shop apparatuses 3 that have been previously registered. In this case, as will be described later, shop apparatus 3 checks whether or not the communication setting data is communication setting data of an effective electronic coupon based on condition data in this data. As another method, in a case in which management server 5 previously has information related to shop apparatus 3 and a shop in which this apparatus is placed, it is possible to employ a configuration in which CPU 51 of management server 5 checks communication setting data in the electronic coupon to be transmitted in the transmission in step S103, and transmits this communication setting data only to shop apparatus 3 for which this electronic coupon is effective in condition data. This eliminates necessity of the check by shop apparatus 3.

It should be noted that while only the communication setting data in the electronic coupon is transmitted to shop apparatus 3 in this example, it is sufficient as long as at least the communication setting data is transmitted, and the electronic coupon itself can be transmitted.

Next, CPU 51 creates an e-mail to be sent and attaches an electronic coupon as attached data (step S105), and sends the e-mail to mobile device 1 (step S107). An e-mail address of destination mobile device 1 is assumed to be inputted by each user of mobile device 1 when membership registration and recorded in a specific storage area of storage unit 55.

In management server 5, a series of processing as described above is repeated. With this, when there is an electronic coupon to be transmitted at predetermined timing, the electronic coupon is transmitted to each shop apparatus 3 and registered mobile device 1.

Next, referring to FIG. 9, in shop apparatus 3, CPU 31 checks whether or not the communication setting data in the electronic coupon transmitted from management server 5 in step S103 is received at predetermined timing such as after power activation (step S301). If received (YES in step S301), CPU 31 stores the communication setting data in a predetermined storage area of storage unit 35 that is previously defined (step S303). It should be noted that if the communication setting data has been received before, the previously received communication setting data is overwritten and the communication setting data later sent becomes effective.

Next, CPU 31 checks the condition data in the stored communication setting data to determine whether or not the electronic coupon is effective at this time point (step S305). For example, when this time point has already passed an effective period of this electronic coupon included in the condition data, when the shop name included in the condition data is different from the shop name in which shop apparatus 3 is placed, or when the position of the shop included in the condition data is different from the position of the shop in which shop apparatus 3 is placed, CPU 31 determines that this communication setting data is of an electronic coupon that is not effective.

If it is determined that the communication setting data is of the effective electronic coupon at this time point as a result, CPU 31 sets such as an SSID, a security method, and a password to wireless access point 37 based on the communication data of the communication setting data (step S307). However, if the same has been set to wireless access point 37, CPU 31 skips the process in step S307.

It should be noted that the determination whether or not the communication setting data is of the effective electronic coupon can be performed when storing the communication setting data in the predetermined storage area in storage unit 35 in step S303, instead of step S305. It is possible to employ a configuration in which upon reception of the communication setting data from management server 5, CPU 31 checks the condition data of this communication setting data, stores the communication setting data in storage unit 35 only if the communication setting data is of an effective electronic coupon, and destroys the received communication setting data if not.

Then, CPU 31 executes a connecting process for establishing communication connection with mobile device 1 (step S309). The connecting process in step S309 will be described later. As a result of this process, if the communication connection with mobile device 1 is successfully established, CPU 31 receives the condition data from mobile device 1 (step S311), and checks the condition data received from management server 5 against the condition data received from mobile device 1. As a result, if these pieces of condition data match (YES in step S313), CPU 31 performs a process for transmitting a signal indicating “communication allowed” to mobile device 1 (step S315). If these pieces of condition data do not match (NO in step S313), CPU 31 performs a process for transmitting a signal indicating “communication not allowed” and transmits the signal (step S317), and disconnects the communication with mobile device 1 (step S319).

FIG. 9 shows the process for storing the communication setting data from management server 5 in steps S301 to S303, the process for setting wireless access point 37 based on the stored communication setting data in steps S305 to S307, and the process for communicating with mobile device 1 based on the communication setting data in steps S309 to S313 in a sequential flow. However, CPU 31 is not necessarily required to execute these processes in a sequential flow. As a different example, the process for storing the communication setting data from management server 5 in steps S301 to S303 and the process for setting wireless access point 37 based on the stored communication setting data in steps S305 to S307 can be respectively performed at timing, as the predetermined timing, at which power of shop apparatus 3 is activated and at which an instruction to check the communication setting data is made by the user of shop apparatus 3, for example. Further, CPU 31 can perform these processes individually and terminate these processes. The process for communicating with mobile device 1 based on the communication setting data in steps S309 to S313 can also be performed at timing, as the predetermined timing, at which an instruction is made by the user of shop apparatus 3 or at which a previously set time comes, for example. Moreover, CPU 31 can repeat this process at predetermined intervals.

By performing such processes in shop apparatus 3, it is possible to establish communication with mobile device 1 that has entered a range in which communication with shop apparatus 3 is possible and storing an electronic coupon effective at this shop, and to notify of such to mobile device 1.

The process of and after step S309 described above is repeated every time when mobile device 1 is present in the range in which communication is possible. With this, it is possible to communicate only with mobile device 1 having the condition data that matches the condition data of the communication setting data that has been previously obtained out of mobile devices 1 present in the range in which communication is possible.

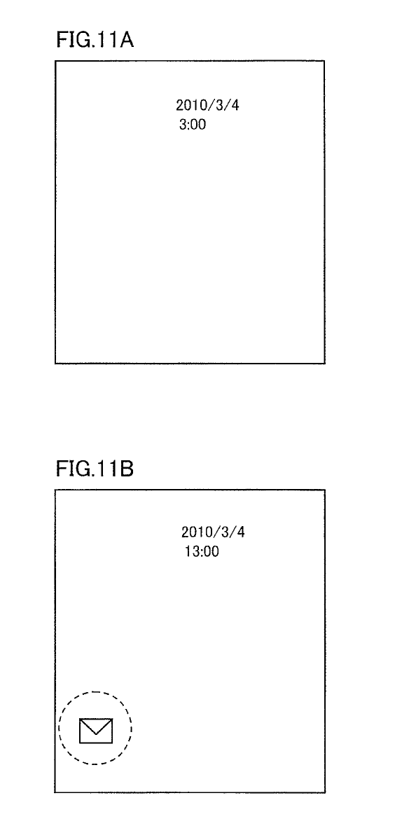

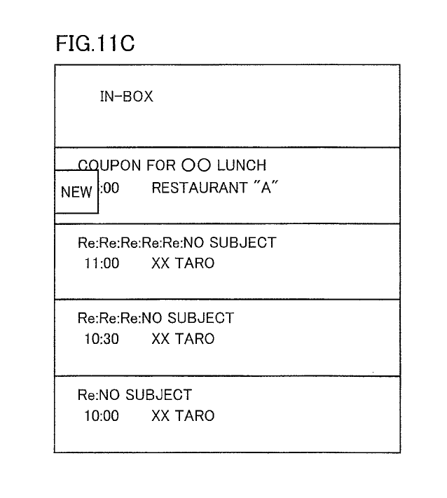

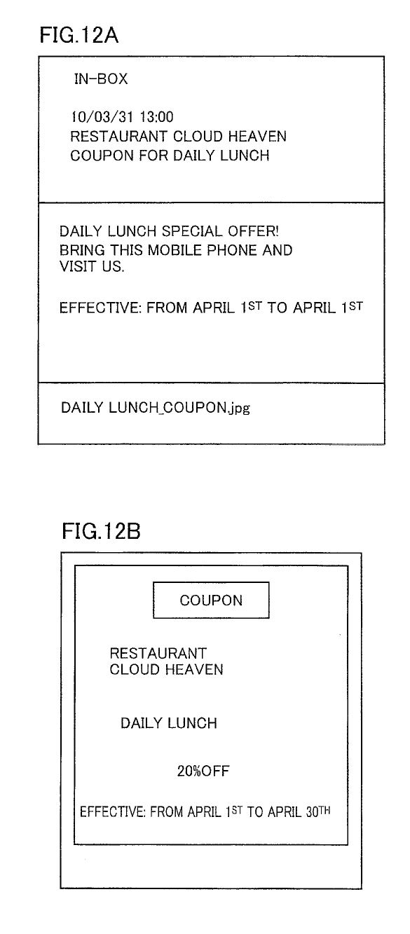

FIGS. 11A to 11C and FIGS. 12A to 12C are views each illustrating a specific example of a display screen of mobile device 1. The processes by mobile device 1 are described with reference to illustrated examples of the display screen of mobile device 1. In mobile device 1, a standby screen illustrated in FIG. 11A is displayed after power activation, and then a process in FIG. 10 starts at predetermined timing.

Referring to FIG. 10, upon starting of the process, CPU 11 accesses management server 5 that also functions as a mail distribution server to inquire if there is a newly arriving e-mail (step S501). As a result, if there is a newly arrived e-mail (YES in step S501), CPU 11 performs a process for automatically receiving the e-mail from management server 5 without accepting an operation from operation unit 12 (step S503). Then, CPU 11 stores the received e-mail and an electronic coupon attached to this e-mail as attached data in an image folder, for example, as the predetermined storage area in storage unit 15 (step S505). At this time, it is preferable that CPU 11 notify of the reception of the newly arrived e-mail, and for example, performs a process for displaying an icon as indicated by a dashed circle in FIG. 11B in display unit 13.

It should be noted that selecting the icon by operating the arrow key and the enter key in this state changes the display screen to a message list (in-box) screen illustrated in FIG. 11C, and selecting the newly arrived e-mail to which the electronic coupon is attached in the list in the same manner changes the display screen to a screen illustrated in FIG. 12A showing the e-mail to which the electronic coupon is attached. Further, selecting, by operating the arrow key and the enter key, to instruct to display the electronic coupon as the attached image data in the screen showing the e-mail (daily lunch_coupon.jpg) changes the display screen to a screen showing the image data of the electronic coupon in FIG. 12B.

Next, CPU 11 searches an electronic coupon recorded in the predetermined storage area such as the image folder, for example, at predetermined timing (step S507). Examples of a searching method include a method using a data structure of an electronic coupon. Specifically, as an electronic coupon has a structure as illustrated in FIG. 6, it is possible to determine whether or not the recorded image data is an electronic coupon by determining whether or not the communication setting data is present in the image data.

If an electronic coupon is present as a result of the search (YES in step S509), CPU 11 executes a connecting process (step S511). The connecting process in step S511 will be described later. After the connecting process is completed, CPU 11 performs a process for transmitting the condition data included in the communication setting data of the electronic coupon to shop apparatus 3 (step S513).

Thereafter, in response to the above transmission, the signal indicating “communication allowed” or “communication not allowed” that shop apparatus 3 has transmitted in step S311 is received (step S515). If the received signal is the signal indicating “communication allowed” (YES in step S517), CPU 11 performs a process for notifying of this signal (step S519). In this example, the notification is made by displaying the notification in display unit 13. To be specific, as illustrated in FIG. 12C, it is displayed in the screen that shop apparatus 3 with which communication is possible is in the vicinity (within a range in which communication is possible). At this time, in addition to the display in the screen, it is possible to make notification by a vibrating motion (vibration) or sound. It should be noted that when “YES” is selected in the notification screen in FIG. 12C, CPU 11 changes the display screen to the screen showing the electronic coupon illustrated in FIG. 12B.

It should be noted that after the connection of the communication between shop apparatus 3 and mobile device 1 is established, the latest advertising information and such can be transmitted from shop apparatus 3 to mobile device 1. This information can be notified at the same time in step S519.

If the received signal is the signal indicating “communication not allowed” (NO in step S517), CPU 11 disconnects the communication (step S519).

FIG. 10 shows the process for storing the electronic coupon from management server 5 in steps S501 to S505 and the process for using the electronic coupon in steps S507 to S521 in a sequential flow. However, CPU 11 is not necessarily required to execute the two processes in a sequential flow. As a different example, the process for storing the electronic coupon from management server 5 in steps S501 to S505 can be performed at timing, as the predetermined timing, at which power of mobile device 1 is activated or at which an instruction to check the newly arriving e-mail is made by the user, for example. Further, CPU 11 can perform the process up to step S505 and terminate the process. The process for using the electronic coupon in steps S507 to S521 can also be performed at timing, as the predetermined timing, at which a transmission base station has changed, at which an instruction to check the stored electronic coupon is made by the user, or at which a previously set time, such as lunch time, comes, for example. Moreover, CPU 11 can repeat this process at predetermined intervals.

By performing such processes in mobile device 1, upon entering the range in which communication with shop apparatus 3 relating to the electronic coupon that mobile device 1 stores is possible, it is possible to automatically notify that the electronic coupon of this shop is stored.

The connecting process in shop apparatus 3 (S309) and the connecting process in mobile device 1 (S511) are different depending on a type of the communication between shop apparatus 3 and mobile device 1. Therefore, the following describes specific examples of the connecting processes for each type of the communication.

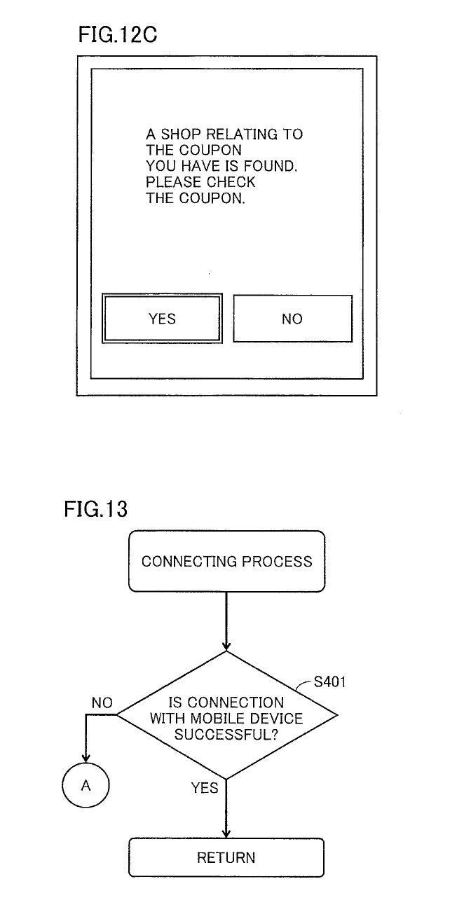

FIG. 13 is a flowchart showing a connecting process in shop apparatus 3 when communication between shop apparatus 3 and mobile device 1 is IEEE 802.11 wireless communication. In step S309, as illustrated in FIG. 13, CPU 31 checks whether or not connection is completed at wireless access point 37. As a result, if the connection is completed (YES in step S401), CPU 31 returns the process to step S311 in FIG. 9. With this, the process of and after step S311 continues in shop apparatus 3. By contrast, if the connection is not completed (NO in step S401), CPU 31 returns the process to step S301 in FIG. 9. With this, the process shown in FIG. 9 is executed from the beginning in shop apparatus 3.

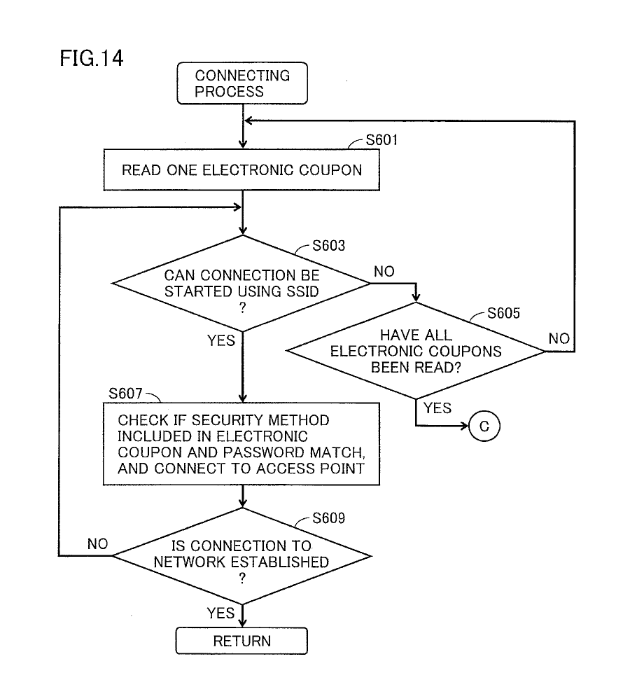

FIG. 14 is a flowchart showing a connecting process in mobile device 1 when communication between shop apparatus 3 and mobile device 1 is IEEE 802.11 wireless communication and when the SSID is not open.

Referring to FIG. 14, CPU 11 first reads one of the electronic coupons searched in step S507 (step S601), and checks if it is possible to start the network connection using the SSID included in the communication setting data of this electronic coupon. If it is determined that it is not possible to start the network connection (NO in step S603), CPU 11 checks if all of the searched electronic coupons have been read. If not (NO in step S605), CPU 11 returns the process to step S601, and further reads a different one of the electronic coupons and repeats the process.

If all of the electronic coupons have been read (YES in step S605), CPU 11 returns the process to step S501 in FIG. 10. With this, the process shown in FIG. 10 is executed from the beginning in mobile device 1. This applies to a case in which mobile device 1 is in a range in which communication is not possible with any shop apparatus 3.

In a case in which mobile device 1 is in the range in which communication with shop apparatus 3 is possible, such as when the user carrying mobile device 1 goes around the shop in which shop apparatus 3 is placed, CPU 11 determines that it is possible to start network connection using the SSID (YES in step S603). In this case, CPU 11 checks if the security method included in the communication setting data and the password match, and attempts a near field wireless access to wireless access point 37 of shop apparatus 3 (step S607). If the connection to wireless access point 37 of shop apparatus 3 is successfully established (step S609), CPU 31 returns the process to step S513 in FIG. 10. With this, the process of and after step S513 continues in mobile device 1.

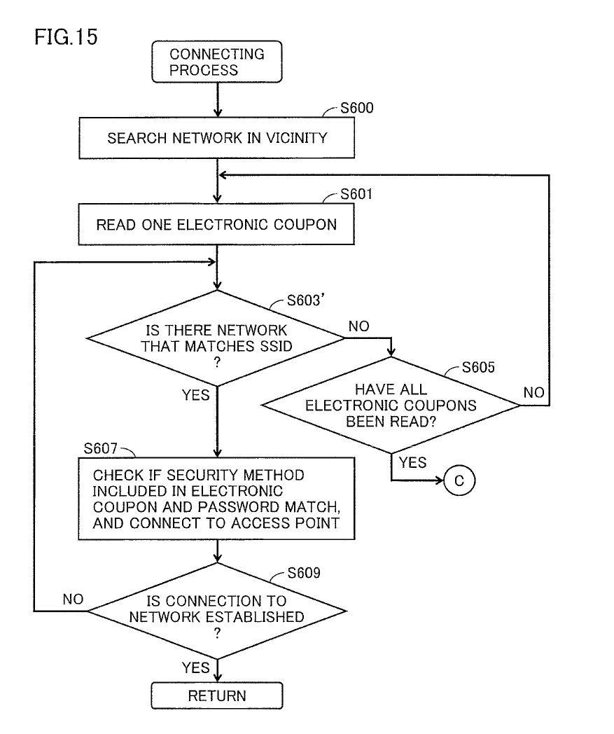

FIG. 15 is a flowchart showing a connecting process in mobile device 1 when communication between shop apparatus 3 and mobile device 1 is IEEE 802.11 wireless communication and when the SSID is open.

The connecting process shown in FIG. 15 is different from the process in FIG. 14 in that CPU 11 executes a process in step S600 before reading the electronic coupon in step S601 and executes a process in step S603′ in place of the process in step S603. Specifically, in this case, in step S600, CPU 11 searches IEEE 802.11 wireless communication networks in neighboring areas, and obtains a list of networks (a list of SSIDs). Then, in step S601, CPU 11 reads one of the electronic coupons searched in step S507, and checks if the list includes an SSID that matches an SSID included in the communication setting data of this electronic coupon. If the list does not include an SSID that matches an SSID included in the communication setting data of this electronic coupon (NO in step S603′), CPU 11 executes the process in and after step S605. If the list includes an SSID that matches an SSID included in the communication setting data of this electronic coupon (YES in step S603′), CPU 11 executes the process in and after step S607.

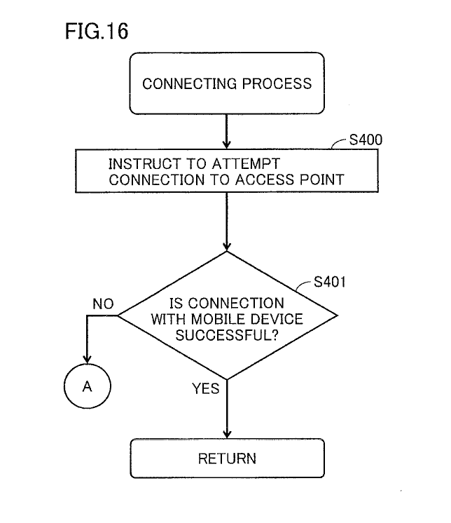

FIG. 16 is a flowchart showing a connecting process in shop apparatus 3 when communication between shop apparatus 3 and mobile device 1 uses Bluetooth®.

The connecting process shown in FIG. 16 is different from the process for performing IEEE 802.11 wireless communication in FIG. 13 in that CPU 31 executes a process in step S400 before checking completion of the connection in step S401. Specifically, in this case, in step S400, CPU 31 instructs wireless access point 37 to attempt to establish connection within its range of communication. With this, if there is mobile device 1 in the range of communication, communication using Bluetooth is performed between shop apparatus 3 and communication unit 36. In step S401, CPU 31 checks whether or not the connection to mobile device 1 is completed at wireless access point 37, and returns the process to step S311 in FIG. 9 if the connection is completed (YES in step S401). With this, the process of and after step S311 continues in shop apparatus 3. By contrast, if the connection is not completed (NO in step S401), CPU 31 returns the process to step S301 in FIG. 9. With this, the process shown in FIG. 9 is executed from the beginning in shop apparatus 3.

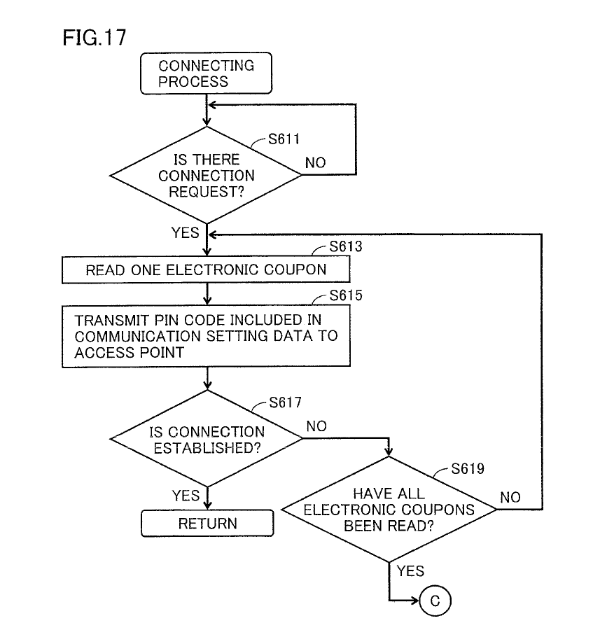

FIG. 17 is a flowchart showing a connecting process in mobile device 1 when communication between shop apparatus 3 and mobile device 1 uses Bluetooth®.

Referring to FIG. 17, if it is determined that there is a connection request from wireless access point 37 according to the process in step S400 in shop apparatus 3 (YES in step S611), CPU 31 reads one of the electronic coupons searched in step S507 (step S613). This applies to a case in which mobile device 1 is present in a range of communication using Bluetooth of shop apparatus 3.

Next, CPU 31 reads a PIN code from the communication setting data in this electronic coupon, and transmits the PIN code to wireless access point 37 of shop apparatus 3 that has made the connection request (step S615). With this, if the Bluetooth connection with shop apparatus 3 that has made the connection request is successfully established (YES in step S617), CPU 31 returns the process to step S513 in FIG. 10. With this, the process of and after step S513 continues in mobile device 1.

If the Bluetooth connection with shop apparatus 3 that has made the connection request is not established (NO in step S617), CPU 31 checks if all of the searched electronic coupons have been read. If not (NO in step S619), CPU 11 returns the process to step S613, and further reads a different one of the electronic coupons and repeats the process.

If all of the electronic coupons have been read (YES in step S619), CPU 11 returns the process to step S501 in FIG. 10. With this, the process shown in FIG. 10 is executed from the beginning in mobile device 1. This applies to a case in which an electronic coupon that allows connection with shop apparatus 3 that has made the connection request is not stored in mobile device 1.

When the distribution system according to this embodiment performs the above-mentioned processes, an electronic coupon that is previously set by management server 5 is transmitted before mobile device 1 enters an area in which the wireless communication with shop apparatus 3 is possible to perform direct communication. Then, in mobile device 1, communication is automatically established when mobile device 1 enters the range of communication of shop apparatus 3, and the notification is made if the stored electronic coupon is an electronic coupon corresponding to shop apparatus 3. Therefore, according to this distribution system, it is possible to distribute an electronic coupon as advertising information before mobile device 1 enters the range in which communication with shop apparatus 3 is possible. With this, it is possible to provide information to guide the user carrying mobile device 1 to the shop even when the user is away from this shop, and thus an effect of attracting customers is expected. Further, when the user carrying mobile device 1 approaches this shop, it is possible to notify the user that a shop related to the held electronic coupon is in the vicinity even if the user is not aware of the shop, and to guide the user to this shop.

It should be noted that, in the above-mentioned example, when the connection is established by satisfying the condition for the communication between mobile device 1 and shop apparatus 3, as well as when the condition that the electronic coupon itself is effective between mobile device 1 and shop apparatus 3, the notification is made that the communication between mobile device 1 and shop apparatus 3 is allowed, in other words, that an electronic coupon of the shop in the range in which communication with mobile device 1 is possible is stored in mobile device 1. However, mobile device 1 can perform the notification process in step S519 as being communicable at timing at which the communication between mobile device 1 and shop apparatus 3 is successfully established by performing the connecting processes described above in both mobile device 1 and shop apparatus 3 without performing determination using the condition for the effectiveness of the electronic coupon, in particular, in a case in which 802.11 wireless communication is used, at timing at which the communication with wireless access point 37 within shop apparatus 3 is successfully established. This facilitates the process, in particular, of the electronic coupon for which any condition is set, for example. Further, it is possible to guide the user to this shop even with such notification, and to expect an effect of attracting customers.

### Modified Example

It should be noted that while the example in which the electronic coupon (distribution data) is transmitted from management server 5 to mobile device 1 via e-mail is shown in the above, the electronic coupon can be transferred through the communication between mobile device 1, can be transmitted via data transmission by a push-based information distribution service, or can be a configuration in which a coupon image shown in a WEB browser is obtained by a user operation. Here, one specific example in which the electronic coupon is transmitted to mobile device 1 from a different mobile device will be described.

In a case in which an electronic coupon is transferred from mobile device 1A to mobile device 1B, between mobile devices 1A and 1B, in addition to the communication via the Internet as described with reference to FIG. 1, near field wireless communication such as infrared communication, Bluetooth®, or Zigbee®, or wire communication can be performed.

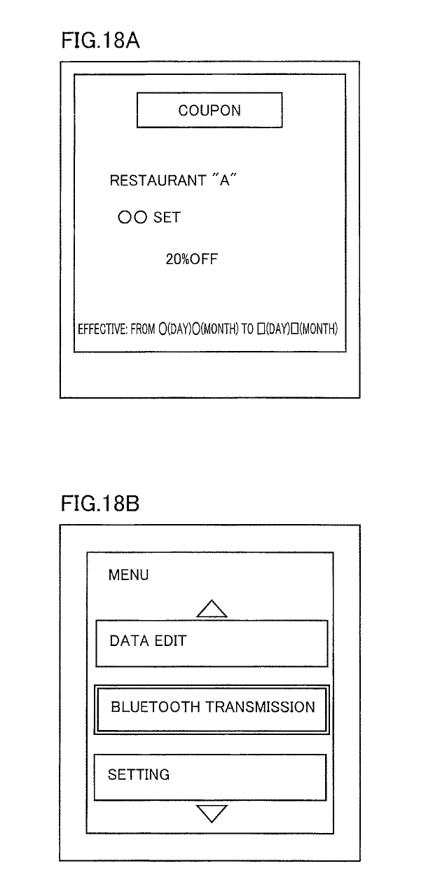

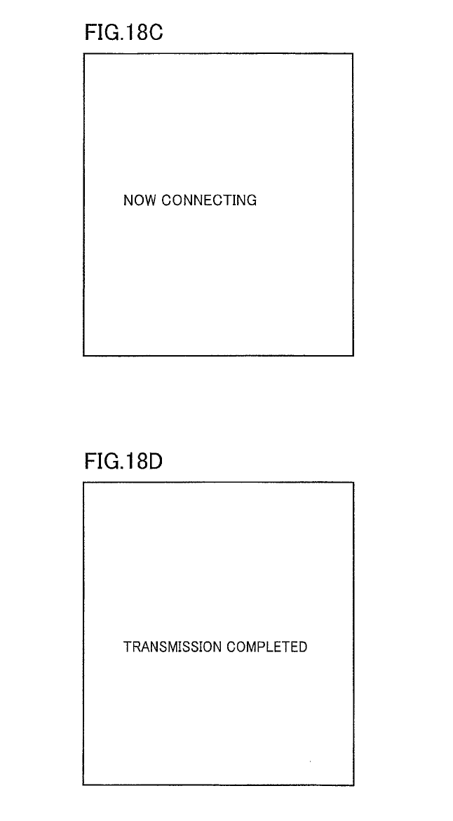

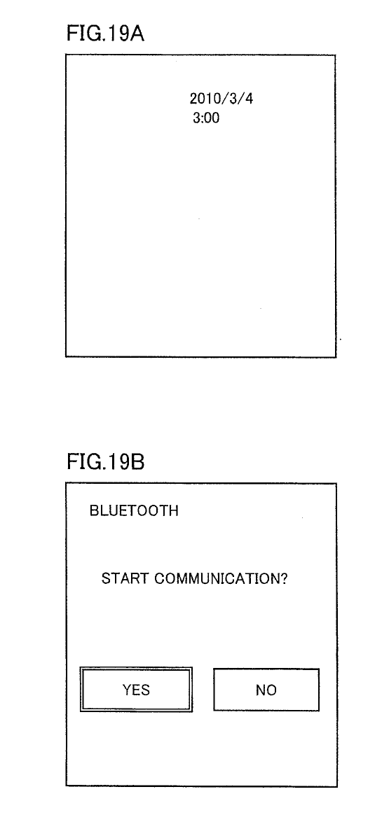

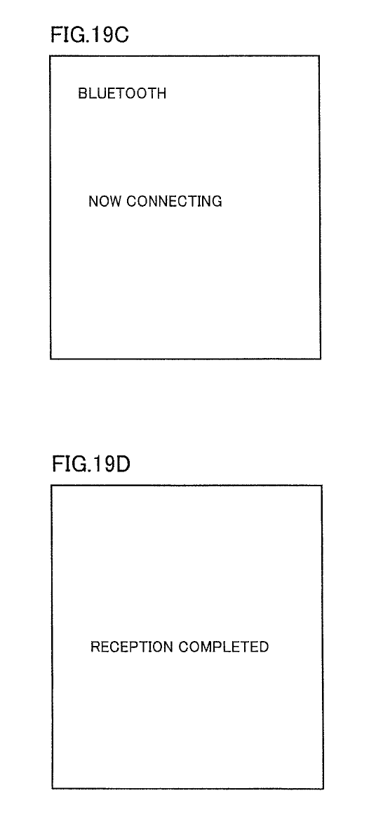

FIGS. 18A to 18D and FIGS. 19A to 19D are views illustrating specific examples of transition of the display screen when the electronic coupon is transferred from mobile device 1A to mobile device 1B through communication using Bluetooth®. FIGS. 18A to 18D show the specific example of the transition of the display screen of mobile device 1A, and FIGS. 19A to 19D show the specific example of the transition of the display screen of mobile device 1B. A specific example of a flow of the transfer is described with reference to these examples of the screen.

FIG. 18A is the view illustrating the display screen when the electronic coupon stored in storage unit 15 is displayed in display unit 13 in mobile device 1A. Pressing a menu key in this screen changes the display screen to a menu screen shown in FIG. 18B. When “Bluetooth Transmission” is selected in the menu screen, CPU 11 transmits an electronic coupon that is image data stored in storage unit 15 through Bluetooth®. At this time, the display screen changes to a screen indicating that the transmission is being performed in FIG. 18C. In this transmission process, CPU 11 searches whether or not a device to which data can be transferred using Bluetooth® is present in the communication range, and if mobile device 1B is found as a target device, executes a process for starting data transfer to the device. Upon completion of the data transfer, the display screen changes to a screen indicating the completion of transmission shown in FIG. 18D.

In receiving-end mobile device 1B, a standby screen shown in FIG. 19A is displayed in display unit 13, and upon reception of a Bluetooth connection request from mobile device 1A, the display screen changes to a screen for selecting to accept or reject the communication shown in FIG. 19B. If “YES” is selected in the screen of FIG. 19B, the display screen changes to a screen indicating that the communication is being performed shown in FIG. 19C, and CPU 11 executes a process for starting the communication with mobile device 1A. Upon completion of reception of the data, the display screen changes to a screen indicating the completion of reception shown in FIG. 19D.

The electronic coupon distributed from management server 5 to mobile device 1 can be transmitted and received between mobile devices 1 in this manner.

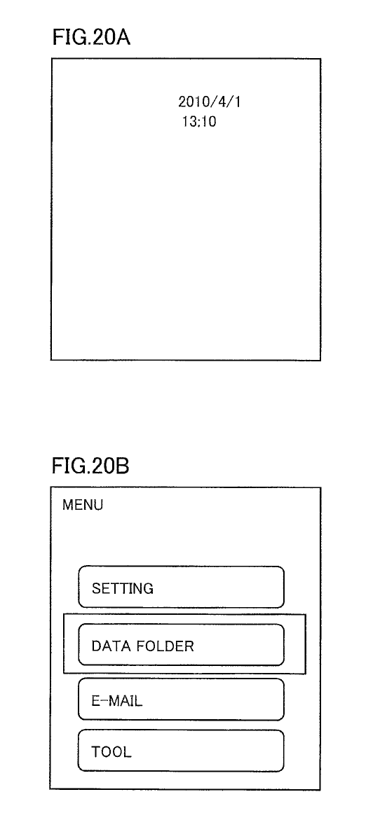

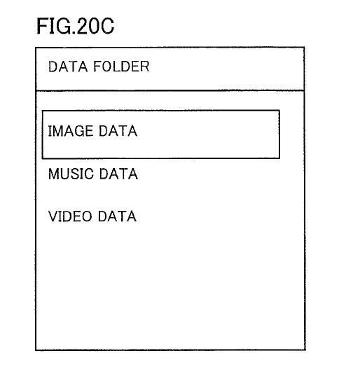

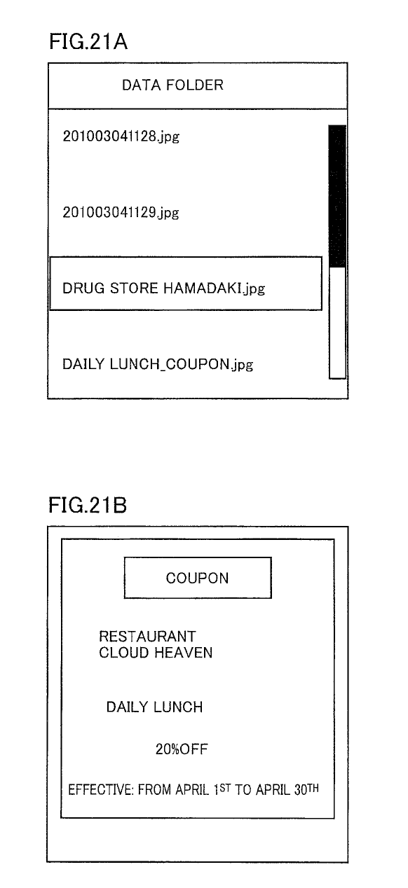

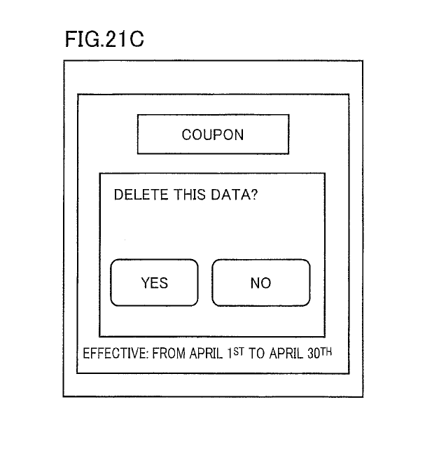

It should be noted that, the electronic coupon stored in storage unit 15 of mobile device 1 can be deleted by a user operation. FIGS. 20A to 20C and FIGS. 21A to 21C are views illustrating specific examples of transition of the display screen of mobile device 1 when the electronic coupon stored in storage unit 15 of mobile device 1 is deleted. A specific example of a flow of the deletion is described with reference to these examples of the screen.

In mobile device 1, a standby screen shown in FIG. 20A is displayed in display unit 13, and upon pressing the enter key when there is no newly arrived e-mail, the display screen changes to a menu screen shown in FIG. 20B. In the menu screen, by moving a focus up and down by the arrow key, and by pressing the enter key when “data folder” is focused, the display screen changes to a screen showing the data folder shown in FIG. 20C. In the screen showing the data folder, by moving a focus up and down by the arrow key, and by pressing the enter key when “image data” is focused, the display screen changes to a screen showing a list of image data shown in FIG. 21A. In this screen, by moving a focus up and down by the arrow key, and by pressing the enter key when “daily lunch_coupon.jpg” is focused, CPU 11 executes a process for displaying the electronic coupon of the selected image data, and a screen shown in FIG. 21B is displayed.

By pressing a delete button in a state in which the screen in FIG. 21B is displayed, a screen asking whether or not the deletion is to be performed is displayed as illustrated in FIG. 21C. If “YES” is selected in this screen, CPU 11 executes a process for deleting the displayed electronic coupon from storage unit 15. Then, the screen changes to the screen showing the list of image data shown in FIG. 21A. If “NO” is selected, the screen changes to the screen displaying this electronic coupon shown in FIG. 21B.

In the above example, the electronic coupon is configured as image data, and the electronic coupon is stored in the image folder in mobile device 1. Therefore, by deleting this data as described above, even when entering a range in which communication with associated shop apparatus 3 is possible after the deletion, it is possible to prevent such notification from being made.

Further, it is possible to provide programs respectively for executing the process in mobile device 1, the process in shop apparatus 3, and the process in management server 5 as described above. Such a program can be provided as a program product by being recorded in a computer-readable recording medium such as a flexible disk that comes with a computer, a CD-ROM (Compact Disk-Read Only Memory), a ROM (Read Only Memory), a RAM (Random Access Memory), and a memory card. Alternatively, it is possible to provide the program by being recorded in a recording medium such as a hard disk built in a computer. Additionally, it is possible to provide the program by downloading the program via a network.

It should be noted that, the program according to the present invention can be such that necessary modules out of program modules provided as a part of an operating system (OS) of a computer are called at a predetermined sequence and at predetermined timing and causes to execute the process. In this case, the program itself does not include these modules, and the process is executed by cooperating with the OS. Such a program not including a module can be included in the program according to the present invention.

Further, the program according to the present invention can be provided by being incorporated as a part of a different program. In this case, the program itself does not include these modules included in the different program, and the process is executed by cooperating with the different program. Such a program included in the different program can be included in the program according to the present invention.

The provided program product is executed by being installed in a program storage such as a hard disk. It should be noted that the program product includes the program itself and the recording medium having the program recorded therein.

The embodiment disclosed herein is for illustration purposes only and shall not be construed as limiting in any means. It will be appreciated that the present invention is only limited by the claims and not by the above description, and includes any modification within the scope of the claims and equivalence thereof.

### REFERENCE SIGNS LIST

1, 1A, 1B mobile device; 3 shop apparatus; 5 management server; 12, 32, 52 operation unit; 13, 33, 53 display unit; 14, 34, 54 temporary storage unit; 15, 35, 55 storage unit; 16 first communication unit; 17 second communication unit; 18 second communication control unit; 20 header area; 21 EXIF area; 22 makernote area; 23 communication setting data; 36, 56 communication unit; 37 wireless access point; 50 image area; 100 electronic coupon

1. A communication device, comprising:
a communication unit for performing wireless communication with another device or an access point for a network within a predetermined communication range;
a storage unit;
a search unit for searching distribution data in said storage unit, the distribution data containing a communication condition of a predetermined item;
a communication control unit for controlling the communication of said communication unit with said another device or said access point based on said communication condition contained in said distribution data; and
a notification unit for notifying that distribution data that allows communication connection is recorded through an output unit after the communication of said communication unit with said another device or said access point is established.

2. The communication device according to claim 1, wherein
said distribution data is configured as image data, and said communication condition is included in header information of the image data.

3. The communication device according to claim 1, wherein
said communication condition contained in said distribution data includes at least one of a network ID for identifying a network through which said wireless communication is performed, a security method, and a password necessary for said wireless communication, and
said communication control unit causes said communication unit to perform the communication with said another device or said access point using at least one of said network ID, said security method, and said password included in said communication condition.

4. The communication device according to claim 1, wherein
said communication condition contained in said distribution data includes a network ID for identifying a network through which said wireless communication is performed, and
said communication control unit causes said communication unit to repeatedly attempt connection to said access point of said network using said network ID.

5. The communication device according to claim 1, wherein
said communication condition contained in said distribution data includes a network ID for identifying a network through which said wireless communication is performed, and
said communication control unit searches one or more networks through which wireless communication is performed, identifies one of the searched networks that matches said network ID as the network through which said wireless communication is performed, and causes said communication unit to connect to said access point of said identified network.

6. The communication device according to claim 1, wherein
said communication condition contained in said distribution data includes a password necessary for said wireless communication, and
said communication control unit performs said password authentication in response to a connection request from said another device, and starts connection between said communication unit and said another device when said authentication is successful.

7. The communication device according to claim 1, wherein
said distribution data is one of data attached to an e-mail distributed from a server and data that said communication unit receives from another device.

8. The communication device according to claim 1, wherein
said notification unit makes said notification when said communication unit establishes the communication with said another device or said access point, and when a predetermined condition is satisfied with said another device.

9. The communication device according to claim 8, wherein
said predetermined condition is reception of a response from said another device, the response indicating that said communication condition contained in said distribution data is satisfied.

10. The communication device according to claim 9, wherein
after said communication unit establishes the communication with said another device or access point, said communication device transmits at least one of information for identifying a facility in which said another device or said access point is placed, information for identifying a position of said facility, and an effective period of said distribution data to said another device, and receives a response indicating whether or not said communication condition contained in said distribution data is satisfied from said another device.

11. The communication device according to claim 1, wherein
said notification unit performs said notification using at least one of vibration, sound, light, and an image.

12. The communication device according to claim 1, wherein
said communication unit performs communication based on a wireless communication method whose communicable range is a near field range.

13. A distribution system, comprising:
a plurality of communication devices, wherein
a first communication device distributes distribution data containing at least a communication condition of a predetermined item to another communication devices,
a second communication device includes:
a communication unit for performing wireless communication with a third communication device or an access point for a network to which said third communication device is connected within a predetermined communication range;
a communication control unit for controlling the communication of said communication unit with said third communication device or said access point based on said communication condition contained in said distribution data distributed from said first communication device; and
a notification unit for notifying that distribution data that allows communication connection is recorded through an output unit after the communication of said communication unit with said third communication device or said access point is established,
said third communication device or said access point includes:
a communication unit for performing wireless communication with another communication device within a predetermined communication range; and
an informing unit for determining whether or not communication of said communication unit with said second communication device is allowed based on said communication condition contained in said distribution data distributed from said first communication device and a communication request from said second communication device, and for informing said second communication device of the determination, and
when said informing unit of said third communication device or said access point has informed that the communication between said second communication device and said third communication device or said access point is allowed, the communication between said second communication device and said third communication device is established.

14. A distribution data processing method for a communication device, said communication device including a communication unit for performing wireless communication with another device and an access point for a network within a predetermined communication range, the method comprising the steps of:
receiving distribution data from another device and storing the distribution data in a recording device;
searching distribution data in said recording device, the distribution data containing a communication condition of a predetermined item;
controlling the communication of said communication unit with said another device or said access point based on said communication condition contained in said distribution data; and
notifying that distribution data that allows communication connection is recorded through an output unit after the communication of said communication unit is established.

15. A distribution data processing program for causing a computer to execute distribution data processing, said computer including a communication unit for performing wireless communication with another device or an access point for a network within a predetermined communication range, the distribution data processing comprising the steps of:
receiving distribution data from another device and storing the distribution data in a recording device;
searching distribution data in said recording device, the distribution data containing a communication condition of a predetermined item;
controlling the communication of said communication unit with said another device or said access point based on said communication condition contained in said distribution data; and
notifying that distribution data that allows communication connection is recorded through an output unit after the communication of said communication unit with said another device or said access point is established.
